(19) United States
(12) Patent Application Publication
(10) Pub. No.: US 2015/0204901 A1
(43) Pub. Date: Jul. 23, 2015

(54) SYSTEM AND METHOD FOR DETERMINING GROUND SPEED OF MACHINE

(71) Applicant: Caterpillar Inc., Peoria, IL (US)

(72) Inventors: Joseph L. Faivre, Edelstein, IL (US); Bradley P. Krone, Dunlap, IL (US)

(73) Assignee: Caterpillar Inc., Peoria, IL (US)

(21) Appl. No.: 14/157,681

(22) Filed: Jan. 17, 2014

(51) Int. Cl. G01P 21/00; G01C 21/16; G01S 19/25

(52) U.S. Cl. CPC G01P 21/00; G01S 19/25; G01C 21/165

(57) ABSTRACT

A method for determining ground speed of a machine includes receiving an inertial navigation data at a first time and calculating a lateral acceleration of the machine at the first time using a first Kalman filter. A time delayed measurement of the ground speed information is received at a second time, wherein the time delayed measurement is delayed by predetermined time interval with respect to the measurement of the inertial navigation data. A ground speed of the machine is calculated at second time based on the time delayed measurement of the ground speed information and the inertial navigation data using a second Kalman filter, wherein the inertial navigation data is provided at the second time. Thereafter the ground speed is then determined based on a change in ground speed of the machine over the predetermined time interval and the calculated ground speed associated with the machine at the second time.

### TECHNICAL FIELD

The present disclosure relates to a system and method for determining a ground speed of a machine, and more particularly to the system and method for reducing a time delay associated with the measurement of the ground speed.

### BACKGROUND

Generally, the ground speed of a machine working in a worksite or mine-site is determined by using a global positioning system (GPS) associated with the machine. The determined ground speed may have an associated time delay largely due to a slow update of the position information from the GPS receiver and also due to the requirement of at least two successive position measurements of the machine to determine the ground speed. Alternatively, the ground speed of the machine is nearly estimated based on a drivetrain output speed of the machine. However, due to a vehicle slip, this method may not provide an accurate estimation of the ground speed.

U.S. Pat. No. 5,787,384 discloses an apparatus and method for determining the velocity of a platform including a GPS receiver and inertial measurement unit (IMU) located at the platform. The GPS receiver provides GPS navigation data using a plurality of GPS satellites while the inertial measurement unit provides an inertial navigation data. An acceleration data computed from the GPS navigation data is combined with the inertial acceleration generated from the IMU using a Kalman filter to generate a substantially IMU-bias free acceleration of the platform. The resultant acceleration measurement and the GPS navigation data are used to calculate the velocity of the platform in conjunction with a second Kalman filter for removing GPS systematic errors that are normally removed by use of a ground reference station.

### SUMMARY

In one aspect, a method for determining a ground speed of a machine is provided. The method receives an inertial navigation data associated with the machine at a first time. A lateral acceleration of the machine is calculated at the first time based on the received inertial navigation data using a first Kalman filter. A time delayed measurement of the ground speed information is received from the positioning system associated with the machine at a second time. The time delayed measurement of the ground speed information is delayed by a predetermined time interval with respect to the measurement of the inertial navigation data. Further, a ground speed associated with the machine is calculated at the second time based on the time delayed measurement of the ground speed information associated with the machine and the inertial navigation data using a second Kalman filter, wherein the inertial navigation data is provided at the second time. Further, a change in ground speed of the machine is determined over the predetermined time interval based on the calculated lateral acceleration of the machine. Furthermore, the ground speed of the machine is determined based on the change in ground speed of the machine over the predetermined time interval and the calculated ground speed associated with the machine at the second time.

In another aspect, a controller for determining a ground speed of a machine is provided. The controller includes a first Kalman filter configured to calculate a lateral acceleration of the machine at a first time based an inertial navigation data received from the IMU. The controller further includes a second Kalman filter configured to calculate a ground speed associated with the machine at the second time based on a time delayed measurement of the ground speed information received from the positioning system and the inertial navigation data, wherein the time delayed measurement of the ground speed information is delayed by a predetermined time interval with respect to the measurement of the inertial navigation data and the inertial navigation data is also provided at the second time. Further, the controller includes a dead reckoning system operatively coupled to the first and the second Kalman filters. The dead reckoning system is configured to determine a change in ground speed of the machine over the predetermined time interval based on the calculated lateral acceleration of the machine. Further, the dead reckoning system is configured to determine the ground speed of the machine based on the change in ground speed of the machine over the predetermined time interval and the calculated ground speed associated with the machine at the second time.

In a yet another aspect, a machine is provided. The machine includes a frame supported on a set of tracks, an inertial measurement unit (IMU) and a positioning system. The machine further includes a drivetrain based ground speed determining module and a controller operatively connected to the IMU, the positioning system and the drivetrain based ground speed determining module. The controller includes a first Kalman filter configured to calculate a lateral acceleration of the machine at a first time based an inertial navigation data received from the IMU. The controller further includes a second Kalman filter configured to calculate a ground speed associated with the machine at the second time based on a time delayed measurement of the ground speed information received from the positioning system and the inertial navigation data, wherein the time delayed measurement of the ground speed information is delayed by a predetermined time interval with respect to the measurement of the inertial navigation data and the inertial navigation data is also provided at the second time. Further, the controller includes a dead reckoning system operatively coupled to the first and the second Kalman filters. The dead reckoning system is configured to determine a change in ground speed of the machine over the predetermined time interval based on the calculated lateral acceleration of the machine. Further, the dead reckoning system is configured to determine the ground speed of the machine based on the change in ground speed of the machine over the predetermined time interval and the calculated ground speed associated with the machine at the second time.

Other features and aspects of this disclosure will be apparent from the following description and the accompanying drawings.

### BRIEF DESCRIPTION OF THE DRAWINGS

FIG. 1 illustrates an exemplary machine, according to an embodiment of the present disclosure;

FIG. 2 illustrates a schematic representation of the machine having a controller for determining a ground speed of the machine, according to an embodiment of the present disclosure;

FIG. 3 illustrates a schematic representation of the machine having a controller for determining a ground speed of the machine, according to another embodiment of the present disclosure; and

FIG. 4 is a flowchart for a method of determining a ground speed of the machine.

### DETAILED DESCRIPTION

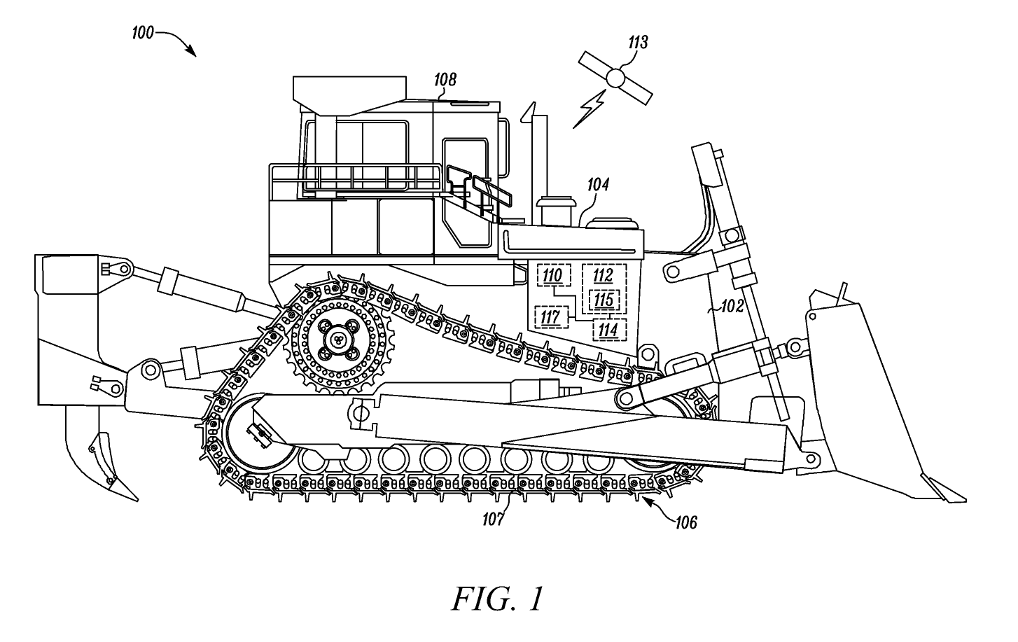

The present disclosure relates to a system and method for determining a ground speed of a machine and reducing a time delay associated with the measurement of the ground speed of the machine. References will now be made in detail to specific embodiments or features, examples of which are illustrated in the accompanying drawings. Wherever possible, the same reference numbers will be used throughout the drawings to refer to the same or like parts. FIG. 1 illustrates an exemplary machine 100. In an embodiment, the machine 100 is illustrated as a track type tractor (TTT). In various alternative embodiments, the machine 100 may be any other on-road and off-road machine such as, a backhoe loader, a wheel loader, a compactor, an excavator, a large mining truck, a skid steer loader, or any other agricultural, mining or construction machinery employing wheels or tracks.

As illustrated in FIG. 1, the machine 100 includes a chassis or a frame 102. An engine enclosure 104 is supported on the frame 102 and houses a power source (not shown) to provide power to the machine 100. The power source may embody an internal combustion engine such as, for example, a diesel engine, a gasoline engine, a gaseous fuel powered engine, or any other type of engine apparent to one skilled in the art. The power source may alternatively or additionally include a non-combustion source of power such as a fuel cell, a power storage device, an electric motor, or any other power source.

A set of ground engaging members 106 such as tracks, or alternatively wheels, rollers, and the like may also be provided on the machine 100 for the purpose of mobility. In the illustrated embodiment, the ground engaging members 106 associated with the machine 100 include a pair of tracks 107 disposed on each side of the frame 102. Further, the machine 100 includes an operator cab 108 which houses controls and/or operator display devices (not shown) for operating and/or monitoring the machine 100. Operator display device may be one of a liquid crystal display, a CRT, a PDA, a plasma display, a touchscreen, a monitor, a portable hand-held device, or any other display known in the art.

The machine 100 further includes an inertial measurement unit (IMU) 110, hereinafter referred to as the IMU 110. The IMU 110 is configured to determine a movement information associated with the machine 100 which may include data such as, but not limited to, orientation, rotation, and acceleration of the machine 100. The IMU 110 is operatively connected to a controller 114 thus the movement information may be used as an input for achieving steering, braking, propulsion or any other type of control for the machine 100.

In an embodiment, the IMU 110 may include a number of sensors associated with the machine 100, and configured to measure a plurality of inertial navigation data associated with the machine 100. For example, the IMU 110 may include one or more accelerometers, inclinometers, gyroscopic sensors, magnetometers and other type of orientation sensors/or a combination thereof associated with the machine 100 to measure the inertial navigation data associated with the machine 100. The inertial navigation data may contain acceleration information including, but not limited to, horizontal, vertical, and forward accelerations, and angular rate information such as inclination angle (e.g., pitch rate), inclination angular rate, heading, yaw rate, roll angle, roll rate, etc. associated with the machine 100. Moreover, the various sensors associated with the IMU 110 may have a measuring latency associated with the sensory measurements and typically this measuring latency is in an order of milliseconds (ms). In a typical setup, the measuring latency of the associated sensors and the IMU 110 may be indicative of a near real-time measurement of the inertial navigation data associated with the machine 100. According to an aspect of the present disclosure, a first time T1 described in the following description is indicative of a time of the inertial navigation data measurement performed by the IMU 110 based on the measuring latency associated with the sensory measurements of the IMU 110.

The machine 100 further includes a positioning system 112 configured to determine a ground speed information associated with the machine 100. The ground speed information determined by the positioning system 112 is primarily based on position information associated with the machine 100. In an embodiment, the positioning system 112 may be a Global Positioning System (GPS) configured to receive information from one or more satellites 113 to determine the ground speed information associated with the machine 100. The positioning system 112 may include a transceiver 115 disposed onboard or off-board the machine 100 and configured to transmit and/or receive a plurality of signals to and from the satellite 113. The signals may be indicative of position and ground speed information associated with the machine 100. In the typical setup, a measuring latency associated with the positioning system 112 while determining the ground speed information may furnish a time delayed measurement of the ground speed information. This measuring latency associated with the positioning system 112 may be caused by a slower update of the position information by the transceiver 115 and/or due to a requisite of the ground speed information corresponding to at least two successive positions of the machine 100. In an aspect of the present disclosure, a second time T2 described in the following description is indicative of a time of the ground speed information measurement performed by the positioning system 112 based on the measuring latency associated with the positioning system 112. Further, in case the measuring latency associated with the positioning system 112 is greater than the measuring latency associated with the IMU 110, a time delay ΔT associated with the measurement of the ground speed information is provided. The time delay ΔT is a measure of the time delayed measurement of the ground speed information by the positioning system 112 with respect to the measurement of the inertial navigation data at the first time T1. In an exemplary embodiment, the time delay ΔT (i.e. T1-T2) is in a range of about 0.5 second to 5 seconds.

According to an embodiment of the present disclosure, the controller 114 is operatively coupled to the IMU 110 and the positioning system 112 and configured to estimate the ground speed of the machine 100 while reducing the time delay ΔT associated with the measurement of the ground speed information by the positioning system 112. The controller 114 is configured to receive the inertial navigation data associated with the machine 100 from the IMU 110, which is measured at first time T1, and the time delayed measurement of the ground speed information associated with the machine 100 from the positioning system 112, which is measured at the second time T2 and thus provides an accurate estimation of the ground speed associated with the machine 100 while reducing the time delay ΔT associated with the measurement of the ground speed information as received from the positioning system 112. Moreover, the machine 100 may include a navigation unit 117 configured to receive, access, and/or store a route plan that is used to control operation of the machine 100. The controller 114 is also in communication with the navigation unit 117 to control the propulsion, the steering, the braking, and the like, to move the machine 100 along the intended travel path based on the position information of the machine 100 and the estimated ground speed.

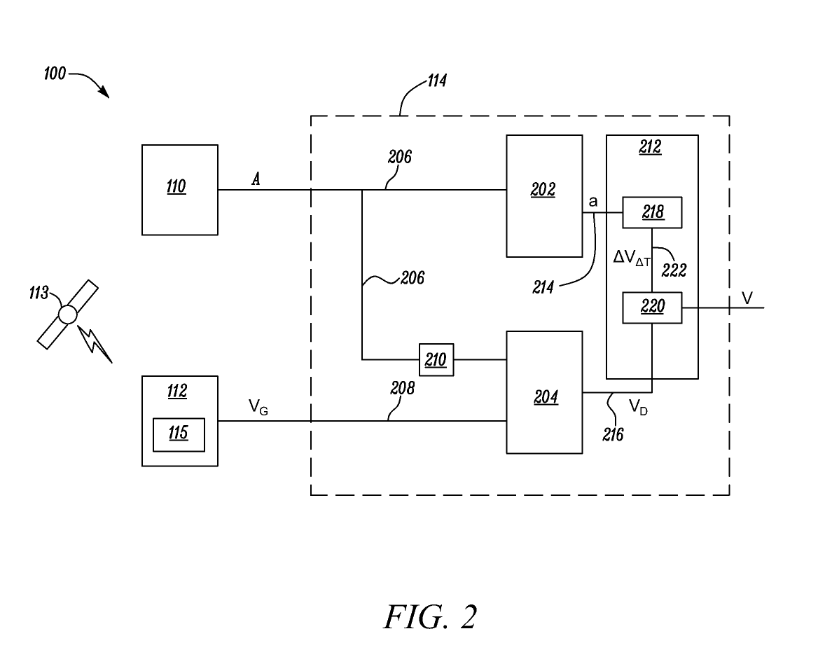

The controller 114, the positioning system 112, the IMU 110 and the navigation unit 117 may each include a processor, such as, for example, a central processing unit, a memory, and an input/output circuit that facilitates communication internal and external to the respective electronic device. The processor may control operation by executing operating instructions, such as, for example, computer readable program code stored in memory, wherein operations may be initiated internally or externally to the respective electronic device 110, 112, 114, and 117. FIG. 2 illustrates a schematic representation of the machine 100 having the IMU 110, the positioning system 112 and the controller 114, according to an embodiment of the present disclosure. The controller 114 may be operatively connected to the IMU 110 and the positioning system 112 via respective communication links such as controller area network (CAN) buses.

In an embodiment of the present disclosure, the controller 114 includes a first Kalman filter 202, and a second Kalman filter 204. The first Kalman filter 202 is operatively connected to the IMU 110 via a first communication link 206. Similarly, the second Kalman filter 204 is operatively connected to the positioning system 112 via a second communication link 208 and the IMU 110 via a first communication link 206. It will be apparent to a person having ordinary skill in the art, the Kalman filters are recursive data processing modules and use a series of measurements received over a period of time along with models of the system and noise sources thereby removing noise and other systematic errors to produce a precise and accurate estimate of a measured variable.

As explained in conjunction with FIG. 1, the IMU 110 measures the inertial navigation data (A) associated with the machine 100 at the first time T1 using the accelerometers, gyroscopic sensors and magnetometers. The IMU 110 is further configured to provide the inertial navigation data (A) to the first Kalman filter 202 and the second Kalman filter 204 over the first communication link 206. The first Kalman filter 202 is configured to calculate a lateral acceleration (a) associated with the machine 100 at the first time T1 based on the inertial navigation data (A) associated with the machine 100 measured at the first time T1 received from the IMU 110. It may be contemplated that the inertial navigation data (A) received from the IMU 110 may be subjected to measurement errors and bias. The first Kalman filter module 202 is further configured to process, remove and/or filter the received inertial navigation data (A) with noise and systematic errors to calculate the lateral acceleration (a) associated with the machine 100 at the first time T1. For example, the first Kalman filter 202 may calculate the lateral acceleration (a) based on the measured acceleration, pitch rate, yaw rate, etc., received from the IMU 110 using known techniques.

In an embodiment, the second Kalman filter 204 is configured to receive the time delayed measurement of the ground speed information (V_{G}) associated with the machine 100 measured at the second time T2 by the positioning system 112 and the inertial navigation data (A) associated with the machine 100 measured at the first time T1 by the IMU 110. The second Kalman filter 204 is configured to calculate a ground speed (V_{D}) associated with the machine 100 at the second time T2 based on the time delayed measurement of the ground speed information (V_{G}) associated with the machine 100 and the inertial navigation data (A). It may be contemplated that the time delayed measurement of the ground speed information (V_{G}) received from the positioning system 112 may also be subjected to measurement errors. The second Kalman filter module 204 is further configured to process, remove and/or filter the received time delayed measurement of the ground speed information (V_{G}) with noise, systematic errors and low update rate to calculate the ground speed (V_{D}) associated with the machine 100 at the second time T2. For example, the second Kalman filter 204 may calculate the ground speed (V_{D}) based on the measured acceleration, pitch rate, yaw rate, etc., received from the IMU 110 and the time delayed measurement of the ground speed information (V_{G}) from the position system 112 using known techniques.

In an exemplary embodiment of the present disclosure, the controller 114 includes a memory module 210. The memory module 210 may include a computer readable memory configured to receive and store the inertial navigation data (A) received from the IMU 110 at the first time T1. The computer readable memory may be any combination of volatile and non-volatile memory, including rotating media, flash memory, conventional RAM, ROM or other non-volatile programmable memory. The memory module 210 is configured to introduce a delay, equal to the time delay ΔT, to provide the inertial navigation data (A) associated with the second time T2 to the second Kalman filter 204. For example, when the second Kalman filter 204 receives the time delayed measurement of the ground speed information (V_{G}) from the positioning system 112 at the second time T2, at the same time, the memory module 304 provides the inertial navigation data (A) corresponding to the second time T2.

In an embodiment, the controller 114 may include a dead reckoning system 212 operatively coupled to the first Kalman filter 202 and the second Kalman filter 204 via a third communication link 214 and a fourth communication link 216, respectively. The dead reckoning system 212 is configured to determine a change in ground speed (ΔV_{ΔT}) of the machine 100 over a predetermined time interval equal to the time delay ΔT. The change in ground speed (ΔV_{ΔT}) over the predetermined time interval corresponds to an estimated increase or decrease in the ground speed based on the calculated lateral acceleration (a) associated with the machine 100 at the first time T1 during the time delay ΔT associated with the time delayed measurement of the ground speed information (V_{G}) by the positioning system 112 with respect to the measurement of the inertial navigation data (A).

The dead reckoning system 212 includes an integrator module 218 and an adder module 220. The integrator module 218 is configured to determine the change in ground speed (ΔV_{ΔT}) over the predetermined time interval. In an exemplary embodiment, the integrator module 218 includes a moving window integrator, which integrates the lateral acceleration (a) associated with the machine 100 at the first time T1 within a moving time interval, which in this case is the predetermined time interval equal to the time delay ΔT associated with the time delayed measurement of the ground speed information (V_{G}) by the positioning system 112 with respect to the measurement of the inertial navigation data (A). Therefore, the integrator module 218 integrates the calculated lateral acceleration (a) within the predetermined time interval from the second time T2 to the first time T1 to determine the change in ground speed (ΔV_{ΔT}) over the predetermined time interval. In an exemplary embodiment, the integrator module 218 may use the following equation to determine the change in ground speed (ΔV_{ΔT}) over the predetermined time interval:

ΔV_{ΔT}=∫_{T1-ΔT}^{T1}adt

Further, the adder module 220 is configured to receive the change in ground speed (ΔV_{ΔT}) over the predetermined time interval from the integrator module 218 via a fifth communication link 222 and the ground speed (V_{D}) associated with the machine 100 at the second time T2 from the second Kalman filter 204. As will be understood by a person ordinarily skilled in the art, the adder module 220 may be an adding logic configured to sum two or more inputs to give an output. Therefore, the adder module 220 may add the change in ground speed (ΔV_{ΔT}) over the predetermined time interval to the ground speed (V_{D}) associated with the machine 100 at the second time T2 to determine a ground speed (V) of the machine 100 at time T1, reducing the time delay ΔT associated with the measurement of the ground speed information (V_{G}) by the positioning system 112, as shown in the following equation:

V=V_{D}+ΔV_{ΔT}

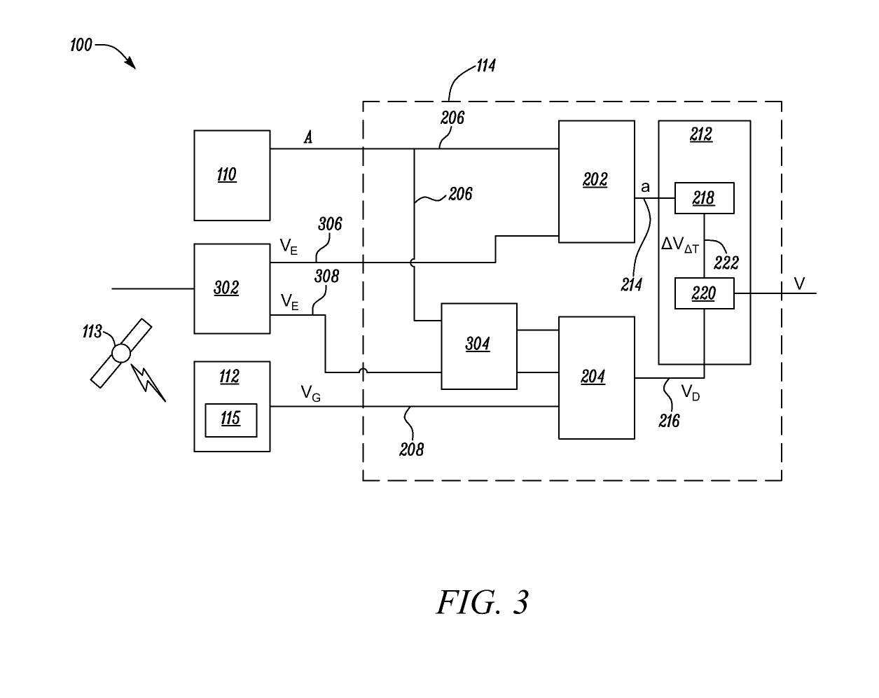

FIG. 3 illustrates a schematic representation of the machine 100 according to another embodiment of the present disclosure. In the illustrated embodiment, the machine 100 is the track type tractor (TTT) having the IMU 110, the positioning system 112 and the controller 114. However, in other embodiments, the machine 100 may be any on-road or off-road machine having tracks 107, wheels or another or means of mobility.

In the illustrated embodiment, the machine 100 includes a drivetrain based ground speed determination module 302, hereinafter referred to as the speed determination module 302, associated with the ground engaging members 106 of the machine 100. The speed determination module 302 is configured to calculate an estimated drivetrain based ground speed (V_{E}) of the machine 100 at the first time T1 based on signals from the drivetrain of the machine 100. The drivetrain based ground speed (V_{E}) of the machine 100 indicates an estimated ground speed of the machine 100 based on a rotational speed of the ground engaging members 106 when the machine 100 is moving. For example, the speed determination module 302 may be communicatively coupled to a plurality of transmission sensors (not shown) configured to measure the rotational speed of the ground engaging members 106.

In an exemplary embodiment, the speed determination module 302 may use a track-soil model to determine the drivetrain based ground speed (V_{E}) of the machine 100. In an alternative embodiment, the speed determination module 302 may determine the drivetrain based ground speed (V_{E}) by using a wheel ground model for wheeled type machines. For example, the speed determination module 302 is configured to use a drawbar pull, track speed, coefficient of traction, etc., to determine the drivetrain based ground speed (V_{E}) of the machine 100. The drawbar pull refers to the actual force delivered to the tracks 107 for moving the tracks 107. The track speed refers to the measured rotational speed with which the tracks 107 rotate and/or move. Further, the coefficient of traction may be indicative of a maximum tractive effort the material or the soil can resist which may vary based on material type. In an alternative embodiment, the speed determination module 302 may use wheel ground model in a similar manner as described above. For example, the speed determination module 302 may use drawbar pull, wheel speed, and the coefficient of traction of the ground the machine is operating on.

In an embodiment, the speed determination module 302 is configured to provide the determined drivetrain based ground speed (VE) of the machine 100 to the first Kalman filter 202 via a sixth communication link 306. The first Kalman filter 202 may utilize the received drivetrain based ground speed (VE) in combination with the inertial navigation data (A) from the IMU 110 to determine the lateral acceleration (a). It may be contemplated that the first Kalman filter 202 comprehensively uses all the inputs, i.e., the inertial navigation data (A) and the drivetrain based ground speed (VE) to estimate the lateral acceleration (a).

In an exemplary embodiment of the present disclosure, the controller 114 includes a memory module 304, the memory module 304 substantially same as the memory module 210 described above. The memory module 304 may include a computer readable memory configured to receive and store the inertial navigation data (A) from the IMU 110, and the drivetrain based ground speed (V_{E}) from the speed determination module 302, both measured at the first time T1. The memory module 304 is connected to the speed determination module 302 via a seventh communication link 308. The memory module 304 is configured to introduce a delay, equal to the time delay ΔT, and provide the inertial navigation data (A) and the drivetrain based ground speed (V_{E}) associated with the second time T2 to the second Kalman filter 204. For example, when the second Kalman filter 204 receives the time delayed measurement of the ground speed information (V_{G}) from the positioning system 112 and, the memory module 304 provides the inertial navigation data (A) and the drivetrain based ground speed (V_{E}) corresponding to the second time T2 to the second filter module 204. The second Kalman filter 204 may comprehensively utilize the time delayed measurement of the ground speed information (V_{G}), the inertial navigation data (A) and the drivetrain based ground speed (V_{E}) at the second time T2 to estimate the ground speed (V_{D}) associated with the machine 100 at the second time T2. Further, the second Kalman filter 204 provides the ground speed (V_{D}) associated with the machine 100 at the second time T2 to the dead reckoning system 212. Subsequently, the dead reckoning system 212 determines the a ground speed (V) of the machine 100 while reducing the time delay ΔT associated with the measurement of the ground speed information (V_{G}) by the positioning system 112 in a similar manner as described above in conjunction with FIG. 2.

### INDUSTRIAL APPLICABILITY

The industrial applicability of the controller 114 within the machine 100 described herein will be readily appreciated from the foregoing discussion. According to an embodiment of the present disclosure, the machine 100 includes the controller 114 that measures the lateral acceleration of the machine 100 and ground speed (V_{D}) at second time T2, which is delayed with respect to the measurement of the lateral acceleration by the time delay ΔT (i.e. T1-T2) using a low cost and low-precision positioning system 112, such as a Cat® Product Link system associated with the machine 100. The controller 114 further determines the change in ground speed (ΔV_{ΔT}) over the predetermined time interval, i.e., from the second time T2 to the first time T1, and adds this change in ground speed (ΔV_{ΔT}) to the ground speed (V_{D}) at second time T2 to determine the ground speed (V) of the machine 100 and essentially reduce the time delay associated with the measurement of a ground speed of the machine 100. The controller 114 disclosed herein is easy to implement, cost efficient and provides an accurate estimation of ground speed (V) of the machine 100.

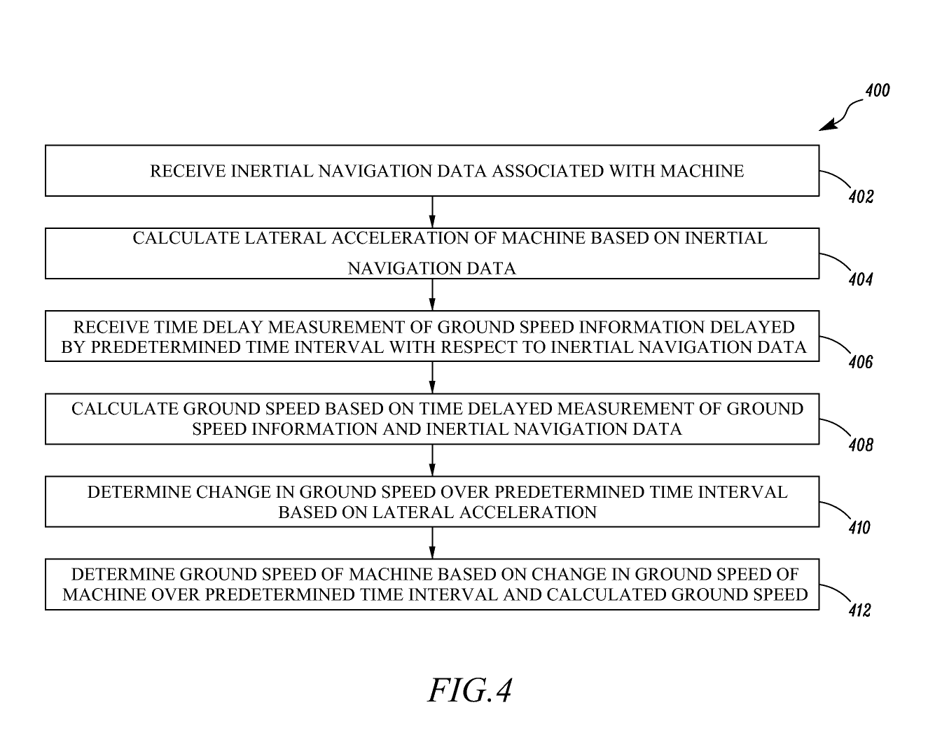

FIG. 4 illustrates a flowchart for a method 400 performed by the controller 114 for determining the ground speed (V) of the machine 100 while reducing the time delay associated with the measurement of a ground speed of the machine 100. At step 402, the controller 114 receives the inertial navigation data (A) associated with machine 100. In an embodiment, the inertial navigation data (A) associated with the first time T1 is received from the inertial measurement unit (IMU) 110. The IMU 110 includes a number of sensors associated with the machine 100 for measuring the inertial navigation data (A) associated with the machine 100. For example, the IMU 110 may include one or more accelerometers, gyroscopic sensors, magnetometers and/or a combination, thereof associated with the machine 100. The inertial navigation data (A) may include horizontal, vertical, and forward accelerations, inclination angle (e.g., pitch), inclination angular rate, heading, yaw rate, roll angle, roll rate, etc. associated with the machine 100.

At step 404, the first Kalman filter 202 of the controller 114 calculates the lateral acceleration (a) of the machine 100 based on the received inertial navigation data (A). The first Kalman filter 202 processes, removes and/or filters the received inertial navigation data (A) with noise to estimate a lateral acceleration (a) of the machine 100. Additionally, the first Kalman filter 202 may estimate the lateral acceleration (a) based on the pitch rate, yaw rate, etc., received from the IMU 110. In an exemplary embodiment, the drivetrain based ground speed (V_{E}) associated with the machine 100, which is estimated by the speed determination module 302, is also used by the first Kalman filter 202 to estimate the lateral acceleration (a) of the machine 100.

At step 406, the controller 114 receives the time delayed measurement of ground speed information (V_{G}) from the positioning system 112 associated with the machine 100 delayed by the predetermined time, equivalent to the time delay ΔT, with respect to the inertial navigation data (A). In an exemplary embodiment of the present disclosure, the controller 114 receives the time delayed measurement of ground speed information (V_{G}) associated with the second time T2. In the following step 408, the second Kalman filter 204 receives the time delayed measurement of ground speed information (V_{G}) from the positioning system 112 and calculates the ground speed (V_{D}) measured at the second time T2 associated with the machine 100 based on the time delayed measurement of ground speed information (V_{G}) and the inertial navigation data (A). In an embodiment, the inertial navigation data (A) received by the second Kalman filter 204 is also delayed to provide the inertial navigation data (A) associated with the second time by the memory module 210 or 304. Moreover, the second Kalman filter 204 may also receive the drivetrain based ground speed (V_{E}) associated with the second time T2 to calculate the ground speed (V_{D}) associated with the second time T2 associated with the machine 100.

At step 410, a change in ground speed (ΔV_{ΔT}) over the predetermined time interval ΔT, i.e., from the second time T2 to the first time T1 is determined. In an embodiment, the integrator module 218 within the dead reckoning system 212 determines the change in ground speed (ΔV_{ΔT}) over the predetermined time interval. The lateral acceleration (a) is integrated with a limit from T2 to T1 to determine the change in ground speed (ΔV_{ΔT}) over the predetermined time interval.

Furthermore, at step 412, the ground speed (V) of the machine 100 is calculated based on the change in ground speed (ΔV_{ΔT}) over the predetermined time interval and the ground speed (V_{D}) associated with the second time T2. In an exemplary embodiment, the adder module 220 receives the change in ground speed (ΔV_{ΔT}) from the integrator module 218 and the ground speed (V_{D}) associated with the second time T2 from the second Kalman filter 204 and adds them to calculate the ground speed (V) of the machine 100 at first time T1.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A method for determining a ground speed of a machine, the method comprising:
receiving an inertial navigation data associated with the machine at a first time;
calculating a lateral acceleration of the machine at the first time based on the received inertial navigation data using a first Kalman filter;
receiving a time delayed measurement of the ground speed information from the positioning system associated with the machine at a second time, wherein the time delayed measurement of the ground speed information is delayed by a predetermined time interval with respect to the measurement of the inertial navigation data;
calculating a ground speed associated with the machine at the second time based on the time delayed measurement of the ground speed information associated with the machine and the inertial navigation data using a second Kalman filter, wherein the inertial navigation data is provided at the second time;
determining a change in ground speed of the machine over the predetermined time interval based on the calculated lateral acceleration of the machine; and
determining the ground speed of the machine at the first time based on the change in ground speed of the machine over the predetermined time interval and the calculated ground speed associated with the machine at the second time.

2. The method of claim 1, wherein receiving the inertial navigation data comprises receiving acceleration information from an inertial measurement unit (IMU) associated with the machine.

3. The method of claim 1, wherein receiving the inertial navigation data comprises receiving an angular rate information from an inertial measurement unit (IMU) associated with the machine.

4. The method of claim 1, wherein receiving the time delayed measurement of the ground speed information at the second time comprises receiving position information from a global positioning system (GPS) associated with the machine and determining the ground speed information based on the position information corresponding to at least two successive positions of the machine.

5. The method of claim 1, wherein calculating the lateral acceleration of the machine further comprises calculating a drivetrain based ground speed of the machine based on at least one of a rotational speed of tracks of the machine and a drawbar pull.

6. The method of claim 1, wherein calculating the ground speed associated with the machine at the second time further comprises receiving a drivetrain based ground speed of the machine based on at least one of a rotational speed of tracks of the machine and a drawbar pull.

7. The method of claim 6, wherein calculating the ground speed associated with the machine at the second time further comprises introducing a delay to provide the drivetrain based ground speed at the second time by a memory module.

8. The method of claim 1, wherein determining the change in ground speed of the machine over the predetermined time interval based on the calculated lateral acceleration of the machine comprises integrating the lateral acceleration within a limit from the second time to the first time.

9. The method of claim 1, wherein determining the ground speed of the machine further comprises adding the change in ground speed of the machine over the predetermined time interval and the calculated ground speed associated with the machine at the second time.

10. A controller for determining a ground speed of a machine, the controller comprising:
a first Kalman filter configured to calculate a lateral acceleration of the machine at a first time based an inertial navigation data received from an inertial measurement unit (IMU) associated with the machine;
a second Kalman filter configured to calculate a ground speed associated with the machine at a second time based on a time delayed measurement of the ground speed information received from a positioning system associated with the machine and the inertial navigation data, wherein the time delayed measurement of the ground speed information is delayed by a predetermined time interval with respect to the measurement of the inertial navigation data and the inertial navigation data is also provided at the second time; and
a dead reckoning system operatively coupled to the first Kalman filter and the second Kalman filter, the dead reckoning system configured to:
determine a change in ground speed of the machine over the predetermined time interval based on the calculated lateral acceleration of the machine; and
determine the ground speed of the machine at the first time based on the change in ground speed of the machine over the predetermined time interval and the calculated ground speed associated with the machine at the second time.

11. The controller of claim 10, wherein the dead reckoning system comprises:
an integrator module configured to integrate the lateral acceleration within a limit from the second time to the first time to determine the change in ground speed of the machine over the predetermined time interval; and
an adder module configured to add the change in ground speed of the machine over the predetermined time interval and the calculated ground speed associated with the machine at the second time.

12. The controller of claim 10, wherein the IMU includes an accelerometer configured to measure acceleration information of the machine and a gyroscopic sensor configured to measure an angular rate information of the machine.

13. The controller of claim 10, wherein the positioning system is a global positioning system (GPS).

14. The controller of claim 10, wherein the first Kalman filter is operatively coupled to a drivetrain based ground speed determination module configured to calculate a drivetrain based ground speed of the machine based on at least one of a rotational speed of tracks of the machine and a drawbar pull.

15. The controller of claim 14 further comprising a memory module configured to introduce a delay to the calculated drivetrain based ground speed.

16. The controller of claim 15, wherein the memory module is operatively connected to the second Kalman filter and configured to provide the inertial navigation data and the calculated drivetrain based ground speed at the second time to the second Kalman filter.

17. A machine comprising:
a frame supported on a set of tracks;
an inertial measurement unit (IMU);
a positioning system;
a drivetrain based ground speed determining module; and
a controller operatively connected to the IMU, the positioning system and the drivetrain based ground speed determining module, the controller comprising:
a first Kalman filter configured to calculate a lateral acceleration of the machine at a first time based an inertial navigation data received from the IMU;
a second Kalman filter configured to calculate a ground speed associated with the machine at a second time based on a time delayed measurement of the ground speed information received from the positioning system and the inertial navigation data, wherein the time delayed measurement of the ground speed information is delayed by a predetermined time interval with respect to the measurement of the inertial navigation data and the inertial navigation data is also provided at the second time; and
a dead reckoning system operatively coupled to the first Kalman filter and the second Kalman filter, the dead reckoning system configured to:
determine a change in ground speed of the machine over the predetermined time interval based on the calculated lateral acceleration of the machine; and
determine the ground speed of the machine at the first time based on the change in ground speed of the machine over the predetermined time interval and the calculated ground speed associated with the machine at the second time.

18. The machine of claim 17, wherein the dead reckoning system comprises:
an integrator module configured to integrate the lateral acceleration within a limit from the second time to the first time to determine the change in ground speed of the machine over the predetermined time interval; and
an adder module configured to add the change in ground speed of the machine over the predetermined time interval and the calculated ground speed associated with the machine at the second time.

19. The machine of claim 17, wherein the IMU includes an accelerometer configured to measure acceleration information of the machine and a gyroscopic sensor configured to measure an angular rate information of the machine.

20. The machine of claim 17, wherein the positioning system is a global positioning system (GPS).
